(19) United States
(12) Patent Application Publication
(10) Pub. No.: US 2026/0314823 A1
(43) Pub. Date: Oct. 15, 2026

(54) Column and Storage Rack

(71) Applicant: Wangwen HUANG, Guangdong Province (CN)

(72) Inventor: Wangwen HUANG, Guangdong Province (CN)

(21) Appl. No.: 19/308,542

(22) Filed: Aug. 25, 2025

(30) Foreign Application Priority Data
Apr. 14, 2025 (CN) 202520707065.3

(51) Int. Cl. A47B 96/14; A47B 47/04; A47B 47/05

(52) U.S. Cl. CPC A47B 96/145; A47B 47/04; A47B 47/05

(57) ABSTRACT

A column and a storage rack having a column are disclosed. The storage rack includes a column body and connecting members. The column body includes at least two main bodies. The at least two main bodies define a mounting groove. Both ends of the column body are respectively provided with mounting grooves. The connecting members correspond to the mounting grooves one by one. The connecting member is configured to be connected to a storage board and is mounted in the mounting groove. A limiting structure is provided between the connecting member and the column body. The limiting structure is configured to limit the connecting member from exiting the mounting groove. In this way, by means of the limiting structure, the connecting member can be stably mounted in the mounting groove, thereby improving the use reliability of the column.

### CROSS-REFERENCE TO RELATED APPLICATION

This application claims priority to Chinese Patent Application No. 2025207070653, entitled “Column and Storage Rack” filed on Apr. 14, 2025, which is incorporated by reference in its entirety.

### TECHNICAL FIELD

The present disclosure relates to the technical field of columns, and in particular, to a column.

### BACKGROUND

A conventional storage rack generally includes a plurality of columns and a plurality of storage boards. The plurality of storage boards are spaced apart in a vertical direction. At least three columns are provided between adjacent storage boards, whereby the columns can support the corresponding storage boards, thereby achieving the storage function of the storage rack. The column is provided with a nut, and the storage board is provided with a screw rod. The screw rod is in thread fit with the nut. During use, the nut is prone to be separated from the column, resulting in insufficient reliability of the column.

### SUMMARY

The present disclosure is intended to resolve at least one of technical problems existing in the related art. To this end, the present disclosure provides a column. The use reliability of the column can be improved.

The present disclosure further provides a storage rack having the foregoing column.

According to an embodiment in a first aspect of the present disclosure, the column includes:
a column body, including at least two main bodies, where the at least two bodies define mounting grooves, and both ends of the column body are respectively provided with the mounting grooves; and
connecting members, corresponding to the mounting grooves one by one, where the connecting member is configured to be connected to a storage board and is mounted in the mounting groove, a limiting structure is provided between the connecting member and the column body, and the limiting structure is configured to limit the connecting member from exiting the mounting groove.

According to the embodiment in the first aspect of the present disclosure, the column at least has the following beneficial effects.

During the production and manufacturing of a column, a connecting member is mounted onto one of main bodies of a column body, followed by sequential connection of the remaining main bodies of the column body. Since at least two main bodies define a mounting groove, the mounting of the connecting member is facilitated. Moreover, a limiting structure is provided between the connecting member and the column body. The limiting structure can limit the connecting member from exiting the mounting groove, so that the connecting member can be stably mounted in the mounting groove, thereby improving the use reliability of the column.

According to some embodiments of the present disclosure, the limiting structure includes a limiting protrusion provided on the connecting member and a limiting groove provided on a side wall of the mounting groove. The limiting protrusion is accommodated in the limiting groove and abuts against a side wall of the limiting groove.

According to some embodiments of the present disclosure, an outer contour of a cross section of the connecting member is a non-circular structure in a direction perpendicular to an axial direction of the column. A cross section of the mounting groove matches the outer contour of the cross section of the connecting member.

According to some embodiments of the present disclosure, the connecting member is provided with a threaded hole. The threaded hole is in thread fit with a screw rod of the storage board.

According to some embodiments of the present disclosure, the at least two main bodies include a first main body and a second main body disposed oppositely. The first main body and the second main body define the mounting groove. A connection structure is provided between the first main body and the second main body.

According to some embodiments of the present disclosure, the connection structure includes an adhesive layer. A side of the first main body facing the second main body is connected to one side of the adhesive layer, and a side of the second main body facing the first main body is adhesively connected to the other side of the adhesive layer.

According to some embodiments of the present disclosure, the column further includes a fastener. The fastener fixedly connects the first main body and the second main body.

According to some embodiments of the present disclosure, an upper end surface and a lower end surface of the column body are separately provided with an avoidance hole communicating with the mounting groove. The avoidance hole is configured for avoiding the screw rod of the storage board.

According to some embodiments of the present disclosure, the connecting member is a plastic part, and/or the main body is a wooden part.

According to an embodiment in a second aspect of the present disclosure, a storage rack includes a plurality of storage boards and a plurality of columns according to the foregoing embodiment. The plurality of storage boards are spaced apart in a vertical direction. At least three of the columns are provided between adjacent storage boards.

According to the embodiment in the second aspect of the present disclosure, the storage rack at least has the following beneficial effects.

During the production and manufacturing of a column according to the embodiment in the first aspect of the present disclosure, a connecting member is mounted onto one of main bodies of a column body, followed by sequential connection of the remaining main bodies of the column body. Since at least two main bodies define a mounting groove, the mounting of the connecting member is facilitated. Moreover, a limiting structure is provided between the connecting member and the column body. The limiting structure can limit the connecting member from exiting the mounting groove, so that the connecting member can be stably mounted in the mounting groove, thereby improving the use reliability of the storage rack.

Additional aspects and advantages of the present disclosure will partially be presented in the following description, and partially become apparent from the following description, or may be learned through the practice of the present disclosure.

### BRIEF DESCRIPTION OF FIGURES

The foregoing and/or additional aspects and advantages of the present disclosure will become apparent and readily understandable from the description of embodiments in conjunction with the accompanying drawings.

FIG. 1 is a schematic structural diagram of a column according to an embodiment of the present disclosure.

FIG. 2 is an exploded view of a column according to an embodiment of the present disclosure.

FIG. 3 is a front view of a column according to an embodiment of the present disclosure.

FIG. 4 is a cross-sectional view taken along a line A-A in FIG. 3.

FIG. 5 is a schematic assembly diagram of a first main body and a connecting member according to an embodiment of the present disclosure.

FIG. 6 is a schematic structural diagram of a connecting member according to an embodiment of the present disclosure.

### REFERENCE NUMERALS

100: column body; 101: mounting groove; 102: limiting groove; 103: avoidance hole; 110: first main body; 111: first groove; 120: second main body; 121: second groove; 200: connecting member; 210: limiting protrusion; and 220: threaded hole.

### DETAILED DESCRIPTION

Embodiments of the present disclosure are described in detail below, with examples of the embodiments illustrated in the accompanying drawings. Throughout the drawings, the same or similar reference numerals denote the same or similar elements or elements with the same or similar functions. The embodiments described with reference to the accompanying drawings are exemplary and are intended solely to explain the present disclosure, and should not be construed as limiting the present disclosure.

In the description of the present disclosure, it should be understood that involved in orientation description, terms indicating orientation or positional relationships such as “upper,” “lower,” “front,” “rear,” “left,” and “right,” are based on the orientation or positional relationships shown in the accompanying drawings. These terms are used solely for the purpose of facilitating the description of the present disclosure and simplifying the description, rather than indicating or implying that the referred device or element must have a specific orientation or be constructed and operated in a specific orientation, and therefore are not to be construed as limiting the present disclosure.

In the description of the present disclosure, the term “several” means one or more, while “a plurality of” means two or more. Terms such as “greater than,” “less than,” and “exceeding” are understood to exclude the reference number, whereas terms such as “above,” “below,” and “within” are understood to include the reference number. Terms such as “first” and “second” are described solely for the purpose of distinguishing technical features and should not be construed as indicating or implying relative importance, implicitly specifying the quantity of the indicated technical features, or implicitly defining the order of the indicated technical features.

In the description of the present disclosure, unless explicitly stated otherwise, terms such as “disposed,” “mounted,” and “connected” should be interpreted broadly. Those skilled in the art may reasonably determine the specific meanings of the foregoing terms in the present disclosure based on the detailed technical solutions.

In the related art, a storage rack generally includes a plurality of columns and a plurality of storage boards. The plurality of storage boards are spaced apart in a vertical direction. At least three columns are provided between adjacent storage boards, whereby the columns can support the corresponding storage boards, thereby achieving the storage function of the storage rack. The column is provided with a nut, and the storage board is provided with a screw rod. The screw rod is in thread fit with the nut. During use, the nut is prone to be separated from the column, resulting in insufficient reliability of the column.

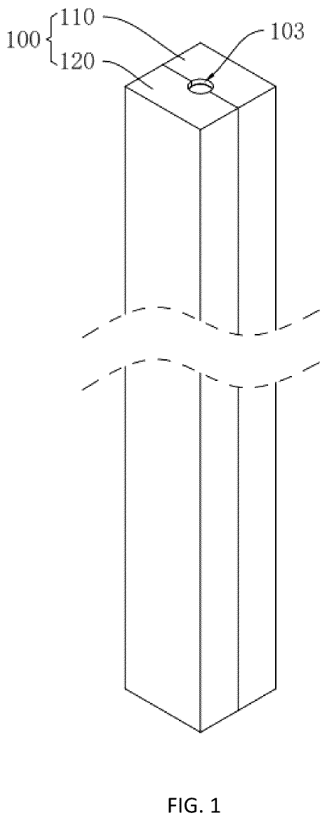

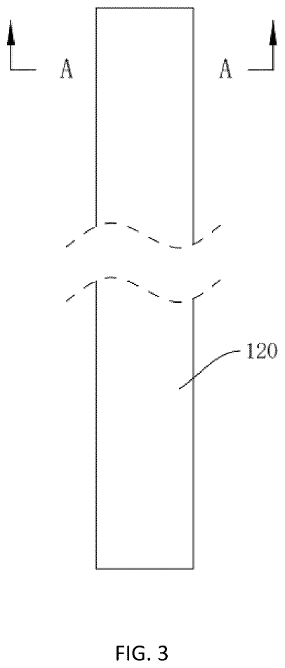

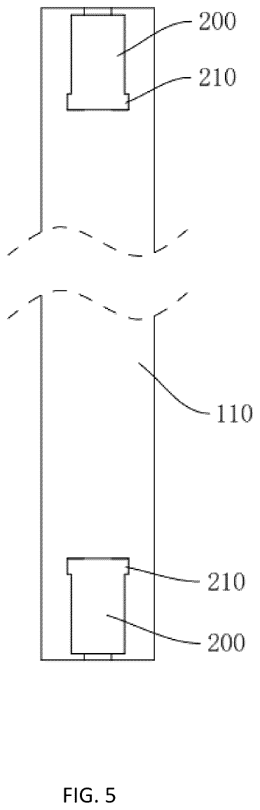

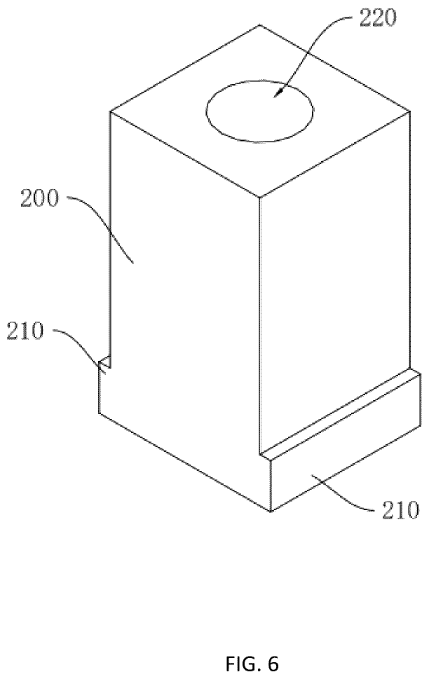

Referring to FIG. 1 to FIG. 6, according to an embodiment in a first aspect of the present disclosure, the column includes a column body 100 and connecting members 200. The column body 100 includes at least two main bodies. The at least two bodies define mounting grooves 101. Both ends of the column body 100 are respectively provided with the mounting grooves 101. The connecting members 200 correspond to the mounting grooves 101 one by one. The connecting member 200 is configured to be connected to a storage board and is mounted in the mounting groove 101. A limiting structure is provided between the connecting member 200 and the column body 100. The limiting structure is configured to limit the connecting member 200 from exiting the mounting groove 101. In this way, by means of the limiting structure, the connecting member 200 can be stably mounted in the mounting groove 101, thereby improving the use reliability of the column.

For example, during the production and manufacturing of a column, a connecting member 200 is mounted onto one of main bodies of a column body 100, followed by sequential connection of the remaining main bodies of the column body 100. Since at least two main bodies define a mounting groove 101, the mounting of the connecting member 200 is facilitated. Moreover, a limiting structure is provided between the connecting member 200 and the column body 100. The limiting structure can limit the connecting member 200 from exiting the mounting groove 101, so that the connecting member 200 can be stably mounted in the mounting groove 101, thereby improving the use reliability of the column.

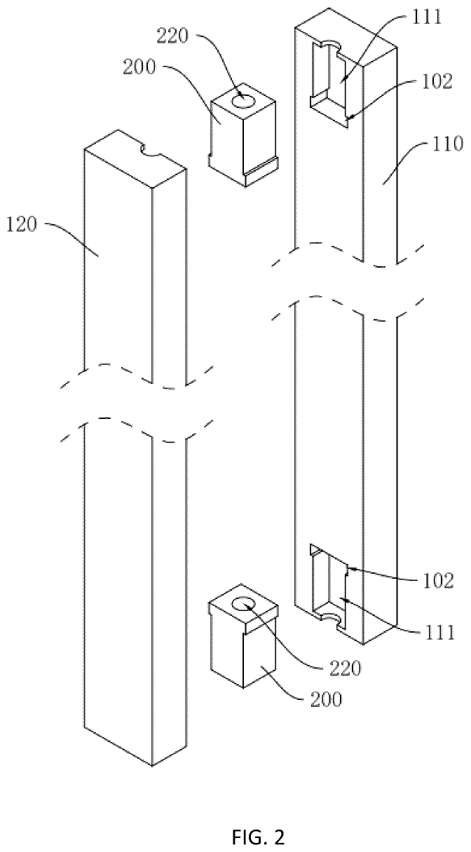

Referring to FIG. 2 to FIG. 4, in some embodiments of the present disclosure, the limiting structure includes a limiting protrusion 210 provided on the connecting member 200 and a limiting groove 102 provided on a side wall of the mounting groove 101. The limiting protrusion 210 is accommodated in the limiting groove 102 and abuts against a side wall of the limiting groove 102. The connecting member 200 can be limited from exiting the mounting groove 101.

For example, two limiting protrusions 210 are configured. One of the two limiting protrusions 210 is provided on one side of the connecting member 200, and the other limiting protrusion is provided on the opposite side of the connecting member 200. Two limiting grooves 102 are correspondingly configured. The limiting protrusions 210 are accommodated in the corresponding limiting grooves 102 and abut against side walls of the corresponding limiting grooves 102. The connecting member 200 can be limited from exiting the mounting groove 101, and the mounting stability of the connecting member 200 can be improved.

It should be noted that positions of the limiting protrusion 210 and the limiting groove 102 may be interchanged. To be specific, the limiting protrusion 210 may be provided on a side wall of the mounting groove 101, while the limiting groove 102 may be provided on the connecting member 200. This is not limited herein.

As another implementation, the limiting structure may alternatively be a structure in which a limiting pin fits a limiting hole. This is not limited herein.

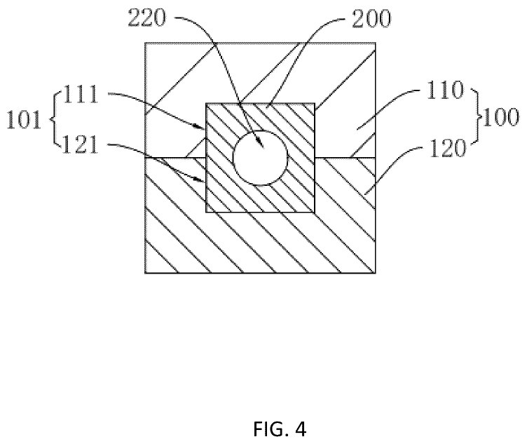

Referring to FIG. 4, in some embodiments of the present disclosure, an outer contour of a cross section of the connecting member 200 is a non-circular structure in a direction perpendicular to an axial direction of the column. A cross section of the mounting groove 101 matches the outer contour of the cross section of the connecting member 200. The rotation of the connecting member 200 relative to the column body 100 can be limited, to facilitate assembly of a storage rack.

For example, an outer contour of a cross section of the connecting member 200 is a rectangular structure in a direction perpendicular to an axial direction of the column. A cross section of the mounting groove 101 is a rectangular structure matching the outer contour of the cross section of the connecting member 200. A peripheral surface of the connecting member 200 abuts against the side wall of the mounting groove 101. The rotation of the connecting member 200 relative to the column body 100 can be limited, to facilitate assembly of the storage rack.

It should be noted that the outer contour of the cross section of the connecting member 200 may alternatively be a polygonal structure or an elliptical structure in the direction perpendicular to the axial direction of the column. This is not limited herein.

In some embodiments of the present disclosure, the connecting member 200 is provided with a threaded hole 220. The threaded hole 220 is in thread fit with a screw rod of the storage board. The assembly of the storage rack can be facilitated.

For example, during the assembly of the storage rack, the screw rod on the storage board is in thread fit with the threaded hole 220 on the connecting member 200. The operation is simple, convenient, and fast. The assembly of the storage rack can be facilitated.

It should be noted that alternatively, the connecting member 200 is provided with a screw rod while the storage board is provided with a threaded hole 220. This is not limited herein.

In some embodiments of the present disclosure, the at least two main bodies include a first main body 110 and a second main body 120 disposed oppositely. The first main body 110 and the second main body 120 define the mounting groove 101. A connection structure is provided between the first main body 110 and the second main body 120. The fixed connection between the first main body 110 and the second main body 120 can be facilitated.

In some embodiments of the present disclosure, the connection structure includes an adhesive layer. A side of the first main body 110 facing the second main body 120 is connected to one side of the adhesive layer, and a side of the second main body 120 facing the first main body 110 is adhesively connected to the other side of the adhesive layer. The fixed connection between the first main body 110 and the second main body 120 can be facilitated.

For example, the first main body 110 is provided with a first groove 111, and the second main body 120 is provided with a second groove 121. The mounting groove 101 is formed between the first groove 111 and the second groove 121. During the assembly of the column, the connecting member 200 is partially mounted in the first groove 111. Subsequently, an adhesive is applied to the side of the first main body 110 facing the second main body 120. The second main body 120 is then closed. After the adhesive cures, the adhesive layer is formed. The fixed connection between the first main body 110 and the second main body 120 can be facilitated.

It should be noted that the connection structure may alternatively be a snap-fit structure. This is not limited herein.

In some embodiments of the present disclosure, the column further includes a fastener. The fastener fixedly connects the first main body 110 and the second main body 120. The reliability of connection between the first main body 110 and the second main body 120 can be improved.

It should be noted that after the first main body 110 is adhered fixedly to the second main body 120 by using an adhesive, the first main body 110 and the second main body 120 are connected fixedly by using a fastener. The fastener is a bolt or a screw. The fixed connection between the first main body 110 and the second main body 120 can be facilitated.

In some embodiments of the present disclosure, an upper end surface and a lower end surface of the column body 100 are separately provided with an avoidance hole 103 communicating with the mounting groove 101. The screw rod of the storage board penetrates into the avoidance hole 103 and is in thread fit with the threaded hole 220 of the connecting member 200. The assembly of the column and the storage board can be facilitated.

In some embodiments of the present disclosure, the main body is a wooden part. The wooden part has low material cost and superior aesthetic appeal.

In some embodiments of the present disclosure, the connecting member 200 is a plastic part. The plastic part has higher structural strength, strong corrosion resistance, and long-term durability.

Referring to FIG. 1 and FIG. 2, according to an embodiment in a second aspect of the present disclosure, a storage rack includes a plurality of storage boards and a plurality of columns according to the embodiment in the first aspect of the present disclosure. The plurality of storage boards are spaced apart in a vertical direction. At least three of the columns are provided between adjacent storage boards. The use reliability of the storage rack can be improved.

Specifically, during the production and manufacturing of a column, a connecting member 200 is mounted onto one of main bodies of a column body 100, followed by sequential connection of the remaining main bodies of the column body 100. Since at least two main bodies define a mounting groove 101, the mounting of the connecting member 200 is facilitated. Moreover, a limiting structure is provided between the connecting member 200 and the column body 100. The limiting structure can limit the connecting member 200 from exiting the mounting groove 101, so that the connecting member 200 can be stably mounted in the mounting groove 101, thereby improving the use reliability of the column.

The various technical features of the foregoing embodiments may be combined in any manner. For the sake of brevity, not all possible combinations of the technical features in the foregoing embodiments have been described. However, any combination of these technical features shall be considered within the scope of this specification, provided that no contradiction arises.

While this embodiment has been described in detail above with reference to the drawings, the present disclosure is not limited to the foregoing embodiments. Within the scope of knowledge possessed by those of ordinary skill in the art, various modifications may be made without departing from the spirit.

What is claimed is:

1. A column, comprising:
a column body (100), comprising at least two main bodies, the at least two bodies defining mounting grooves (101), and both ends of the column body (100) being respectively provided with the mounting grooves (101); and
connecting members (200), corresponding to the mounting grooves (101) one by one, the connecting member (200) being configured to be connected to a storage board and mounted in the mounting groove (101), a limiting structure being provided between the connecting member (200) and the column body (100), and the limiting structure being configured to limit the connecting member (200) from exiting the mounting groove (101).

2. The column according to claim 1, wherein the limiting structure comprises a limiting protrusion (210) provided on the connecting member (200) and a limiting groove (102) provided on a side wall of the mounting groove (101), the limiting protrusion (210) being accommodated in the limiting groove (102) and abutting against a side wall of the limiting groove (102).

3. The column according to claim 1, wherein an outer contour of a cross section of the connecting member (200) is a non-circular structure in a direction perpendicular to an axial direction of the column, and a cross section of the mounting groove (101) matches the outer contour of the cross section of the connecting member (200).

4. The column according to claim 1, wherein the connecting member (200) is provided with a threaded hole (220), the threaded hole (220) being in thread fit with a screw rod of the storage board.

5. The column according to claim 1, wherein the at least two main bodies comprise a first main body (110) and a second main body (120) disposed oppositely, the first main body (110) and the second main body (120) defining the mounting groove (101), and a connection structure being provided between the first main body (110) and the second main body (120).

6. The column according to claim 5, wherein the connection structure comprises an adhesive layer, a side of the first main body (110) facing the second main body (120) is connected to one side of the adhesive layer, and a side of the second main body (120) facing the first main body (110) is adhesively connected to the other side of the adhesive layer.

7. The column according to claim 5, further comprising a fastener, wherein the fastener fixedly connects the first main body (110) and the second main body (120).

8. The column according to claim 1, wherein an upper end surface and a lower end surface of the column body (100) are separately provided with an avoidance hole (103) communicating with the mounting groove (101), the avoidance hole (103) being configured for avoiding the screw rod of the storage board.

9. The column according to claim 1, wherein the connecting member (200) is a plastic part, and/or the main body is a wooden part.

10. A storage rack, comprising a plurality of storage boards and a plurality of columns according to claim 1, wherein the plurality of storage boards are spaced apart in a vertical direction, and at least three of the columns are provided between adjacent storage boards.
